(19) United States
(12) Patent Application Publication
(10) Pub. No.: US 2006/0012628 A1
(43) Pub. Date: Jan. 19, 2006

(54) Transportation pad for ink cartridge

(75) Inventors: Stephen A. Anderson, Thompsons Station, TN (US); William A. Putman, Franklin, TN (US)

Correspondence Address: James W. McKee, Esq.;Fay, Sharpe, Fagan, Minnich & McKee, LLP, Seventh Floor, 1100 Superior Avenue, Cleveland, OH, 44114-2518, US

(73) Assignee: Nu-Kote International, Inc.

(21) Appl. No.: 10/889,723

(22) Filed: Jul. 13, 2004

(51) Int. Cl. B41J 2/165

(52) U.S. Cl. 347/29

(57) ABSTRACT

A device for protecting and sealing ink nozzles of an ink jet cartridge includes a sealing member having a contact portion with a curvilinear contact face for sealing against the nozzles. The cartridge nozzle includes a nozzle plate surrounding the associated ink nozzles which may be in rows. A transport clip for attachment to the ink jet cartridge supports the sealing member for compressional engagement with the nozzle portion thereof when the clip and cartridge are interengaged.

### BACKGROUND OF THE INVENTION

The present invention relates to transportation pads useful for sealing and protecting an ink outlet such as the ink ejection outlet of an ink cartridge, an ink recording head, or an air communication hole, or for fixing, tentatively, an article against the ink outlet of an ink cartridge.

The ink outlet of an ink cartridge typically includes ink nozzles. Conventionally, in an ink jet apparatus, clogging or leaking of the ink nozzles during transportation, or trouble in ink ejection, is prevented by covering the ink ejection outlet face of the cartridge with a capping device or sealing member. Conventional capping devices, which may include flat contact pads, are liable to cause leakage of ink during transportation of an ink jet cartridge owing to rough movement and/or lateral forces on the pads which also can result in dislocation of the pads relative to the ink nozzles during transportation. The leakage leads to soiling of the cartridge as well as the interior of the recording apparatus and/or surrounding enclosure or housing into which the cartridge is inserted for use. Increasing the overall compression force between a pad and the ink nozzles is one method for overcoming the undesired dislocation of the capping device relative to the ink cartridge. This increased compression force, however, has a negative effect on a nozzle plate and/or flexible circuit surrounding the ink nozzles, such as loosening, bending, dislocating the plate, etc. In particular, the nozzle plate can become misaligned or damaged as a result of excessive compression force and increased lateral forces between the plate and the pad.

Another method for sealing an ink outlet is through the use of sealing tape. The sealing tape includes a sealing member with an adhering portion that bonds to a joint portion comprising the nozzle plate and surrounding areas. Another portion of the sealing member includes a bonding area having a pressure sensitive adhesive for holding the sealing member in place over the ink nozzles and adjacent areas. The elongation or bending properties of the sealing member in a thin film form (e.g. a tape) are desired for resistance to environmental variation and for durability. Sealing tape, however, typically degrades with changes to environmental conditions, i.e. temperature and time. Further, a conventional protective sealing tape which is constituted at least of a support and a pressure sensitive adhesive layer laminated thereon, is not satisfactory in sealing of an irregular face, resulting in gradual peeling during long term transport or storage and which peeling causes leakage of ink. If the adhesion force of the sealing tape is increased for more reliable prevention of ink leakage or evaporation and air inflow, the adhesive agent is intensified which results in an undesirable residue of adhesive remaining around the periphery of, and on, the ink ejecting nozzles when the sealing tape is removed. Additionally, sealing tapes cannot be reused effectively for subsequent sealing of the ink nozzles when an ink cartridge is removed from a printer and stored for future use.

In another approach, a cap member is installed over the sealing tape to press the tape by the elastic character of the cap member against the periphery of the ink nozzles. This alternative is a combination of the conventional capping device and the sealing tape and, thus, includes the inherent problems associated with each method and requires the use of two components.

Although many capping devices and sealing devices have been proposed to overcome the aforementioned problems, devices heretofore available have not been satisfactory for sealing an ink outlet so as to maintain sealing engagement over long periods of time and/or over extreme environmental variations. Moreover, sealing devices heretofore available have not been effective in maintaining the orientation of the nozzle plate of a cartridge during installation of the seal and, thereafter, storage, and multiple removals and replacements of the capping and/or sealing device relating to the ink cartridge.

### SUMMARY OF THE INVENTION

The present invention provides an improvement for a transportation pad or sealing member of the type described which overcomes the referred to difficulties and others, and is easy to manipulate, while maintaining appropriate sealing forces on the ink ejecting nozzles. More particularly in this respect, a device is provided for protecting and sealing ink nozzles of an ink jet cartridge which includes a sealing member of resilient material having a compressible contact portion with a profiled contact surface for sealing against an ink nozzle. The nozzle includes a nozzle plate surrounding associated ink nozzles, and the contact surface of the pad is curvilinear and convex in the direction of contact with the nozzle. A transport clip is provided for selective attachment to the ink jet cartridge and supports the sealing member for progressive compressional engagement with the nozzle when the cartridge is assembled therewith and for progressive decompressional disengagement with the nozzle when the cartridge is separated from the clip.

The progressive compression and decompression provided by the curvilinear contact surface of the pad prevents the pad from loosening, bending, dislocating, etc., the nozzle plate and/or flexible circuit from the cartridge during installation and removal, respectively. It will be appreciated that the progressive decompression results in breaking the surface tension between the nozzle plate and pad around the perimeter of the nozzle plate first during cartridge removal from the transport clip. This advantageously progressively reduces the force against and laterally across the nozzle plate to maximize or eliminate the tendency to displace the plate relative to the cartridge.

In accordance with one aspect of the invention, the curvilinear surface can be a single surface profiled to seal against all of the nozzle openings through a nozzle plate, or can be a plurality of separate surfaces profiled to seal against a corresponding line of openings through a nozzle plate. The curvilinear surface may, for example, be dome shaped, in the form of a longitudinal part of a solid cylinder, or curved both longitudinally and laterally.

### BRIEF DESCRIPTION OF THE DRAWINGS

The invention may take physical form in certain parts and arrangements of parts, embodiments of which will be described in detail in the specification, and are illustrated in the accompanying drawings, which form a part hereof and wherein:

FIG. 1 is a perspective view of a transport clip and a sealing pad according to the present invention;

FIG. 2 is a perspective view of an ink cartridge showing the print head portion thereof;

FIG. 3 is an enlarged perspective view of the sealing pad shown in FIG. 1;

FIG. 4 is an enlarged cross sectional elevation view of the sealing pad shown in FIG. 3 in a pre-compressed condition;

FIG. 5 is an enlarged cross sectional elevation view of the pad in FIG. 4 in a compressed condition;

FIG. 6 is an enlarged perspective view of a sealing pad according to a second embodiment of the present invention;

FIG. 7 is an enlarged cross-sectional elevation view of the sealing pad shown in FIG. 6 in a pre-compressed condition;

FIG. 8 is an enlarged cross-sectional elevation view of the pad in FIG. 7 in a compressed condition;

FIG. 9 is an enlarged perspective view of a sealing pad according to a third embodiment of the present invention;

FIG. 10 is an enlarged cross-sectional elevation view of the sealing pad shown in FIG. 9 in a pre-compressed condition; and, FIG. 11 is an enlarged cross-sectional elevation view of the pad in FIG. 10 in a compressed condition.

### DESCRIPTION OF PREFERRED EMBODIMENTS OF THE INVENTION

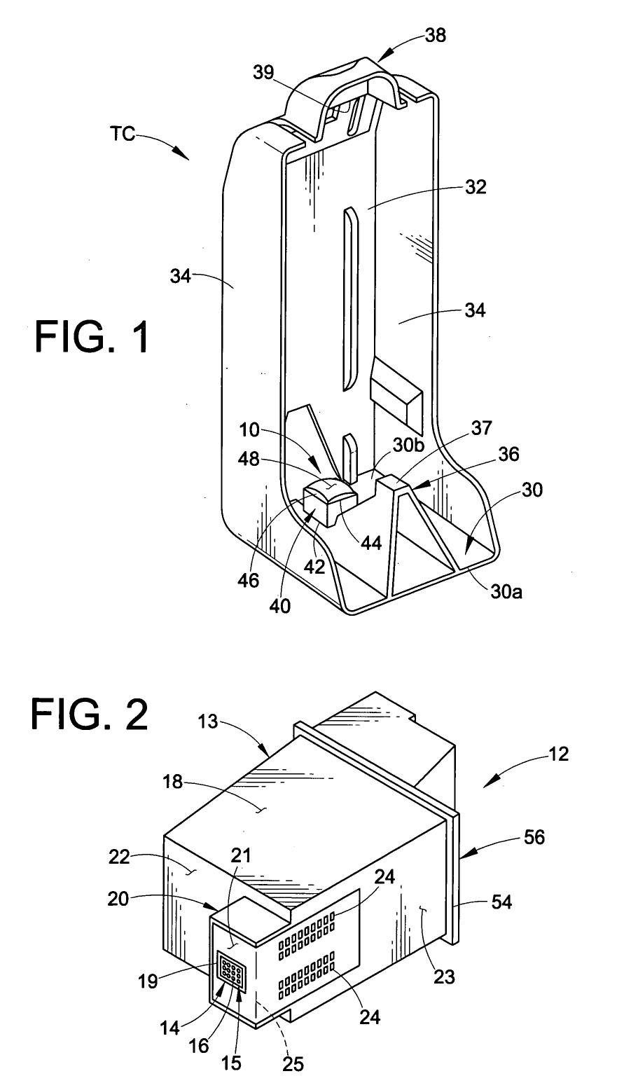

Referring now in greater detail to the drawings, wherein the showings are for the purpose of illustrating preferred embodiments of the invention only, and not for the purpose of limiting the invention, FIG. 1 shows a transport clip TC with a sealing member or pad 10 according to the present invention attached thereto and which clip TC and pad are adapted to be attached to an ink jet cartridge 12 shown in FIG. 2 in the manner and for the purpose set forth more fully hereinafter. Ink jet cartridge 12 comprises an ink jet unit 13 including a print head or nozzle portion 14 on which a nozzle plate 15 having a multiplicity of ink nozzles or orifices 16 therethrough is adhesively mounted. The ink jet unit 13 further includes an ink tank or reservoir 18 for holding ink. The cartridge 12 has a tip portion 20 projecting from a bottom surface 22 of the ink tank 18. The tip portion 20 includes a portion of a flexible circuit 21 located on a bottom surface. The flexible circuit 21 wraps around an edge 25 of the tip portion 20 and terminates along a front surface 23 of ink unit 13. The ink jet cartridge illustrated is fixed and supported by a registration means, which when mounted, has electric contact points or pads 24, is detachable from a carriage mounted on an ink jet recording apparatus, and is disposable.

The transport clip TC, as shown in FIG. 1, is generally L-shaped and comprises a base member 30 having front and rear ends 30a and 30b, respectively, and a rear wall 32 extending upwardly from the base at the rear end thereof. Sealing pad 10 is mounted on the base member 30 adjacent rear end 30b, and the transport clip further includes side walls 34 extending upwardly from the base member and a cartridge support member 36 extending upwardly from base 30 adjacent front end 30a thereof. The upper ends of rear wall 32 and side walls 34 terminate in an inwardly and forwardly projecting flexible retaining clip 38 adapted to releasably interengage with cartridge 12 when the latter is mounted in the transport clip TC to releasably hold the cartridge therein. When the cartridge is assembled with the transportation clip TC, the bottom end of print head 14 facially engages and compresses sealing pad 10, as described hereinafter, bottom surface 22 of the ink tank engages against the upper end of support member 36, and clip 38 releasably inter-engages with the upper end 56 of the cartridge 12.

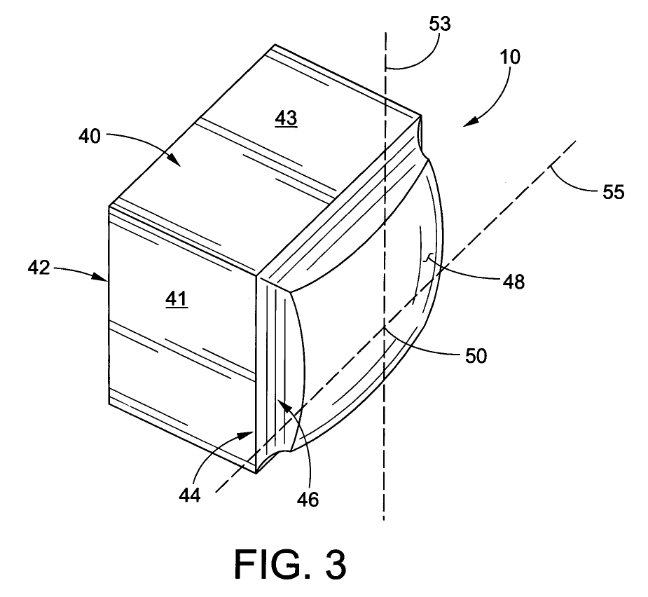

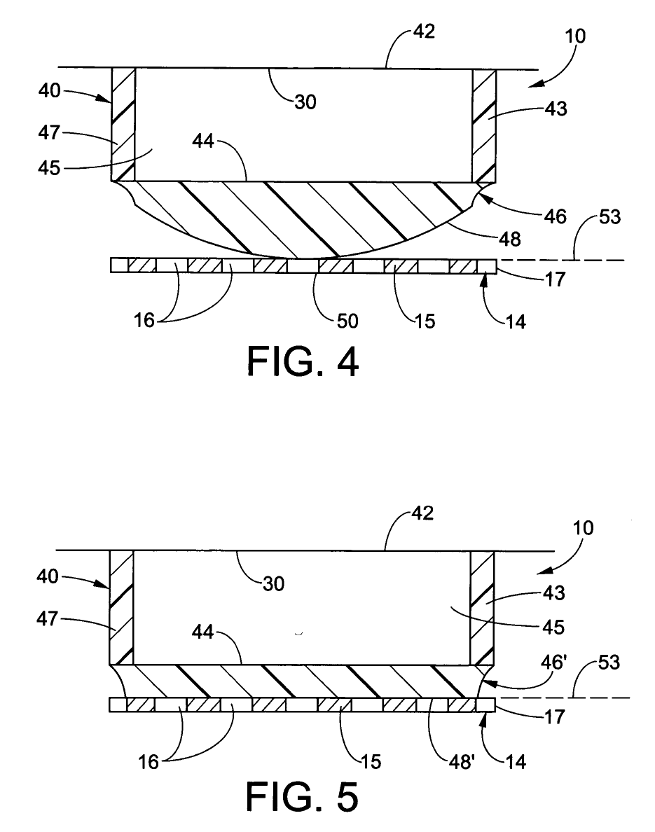

The transport pad 10, as shown in FIG. 3, includes a body 40 which is substantially square, opposed pairs of sidewalls 41 and 43, only one of each pair being visible in FIG. 3, a lower end 42 and an upper end 44. As shown in FIGS. 4 and 5, the body 40 is hollow for mounting on a post 45 on the base member 30 of the transport clip TC. The pad 10 further includes contact portion 46 extending upwardly from upper end 44 and having a profiled contact face or surface 48. The attributes desirable of the transport pad 10 include a pad material, for example silicone, that does not degrade or contaminate the constituent material of the nozzle portion 14, and which pad material is not degraded or contaminated by the nozzle portion 14 and/or the ink. Typically, the ink nozzle orifices 16 are very fine, whereby the contact surface 48 needs to be smooth.

The manner in which the above ink jet cartridge 12 is attached to the transport clip TC is briefly explained. First, the base member 30 of the transport clip TC, including the cartridge support member 36 extending therefrom, is positioned at an angle relative to the nozzle portion 14. As the nozzle portion 14 is moved inwardly across base member 30, cartridge support member 36, and sealing pad 10 are moved toward contact with cartridge surface 22 and nozzle portion 14, respectively. As the cartridge and the transport clip TC are relatively rotated in the direction of assembly, the base member 30 and nozzle portion 14 are moved into parallel alignment. Simultaneous with the transport clip and cartridge reaching the aligned positions, inside surface 39 of the retaining clip 38 engages mounting member 54 on the upper end 56 of the cartridge 12 to releasably interconnect the transport clip and cartridge. When so interconnected, rear wall 32 of the transport clip TC is aligned along the front surface 23 of the ink tank 18 thereby protecting the electric contact points 24 from exposure and inadvertent contact. In the mounted orientation, it is to be appreciated that the transport pad 10 engages the nozzle portion 14 and the nozzle plate 15 on the tip portion 20 of the ink unit 13, while upper end 37 of support member 36 engages the bottom surface 22 of the ink unit 13. When the transport clip TC is mounted, the transport pad 10 is retained between the base member 30 and the nozzle portion 14 and is elastically deformed. As a result, the contact portion 46 and the contact surface 48 of the transport pad 10 is compressed against the nozzle plate 15 and the orifices 16. As described in more detail below, the contact portion 46 of the transport pad 10 supports contact surface 48 for compression against the nozzle plate and orifices 16, thus sealing all of the orifices 16.

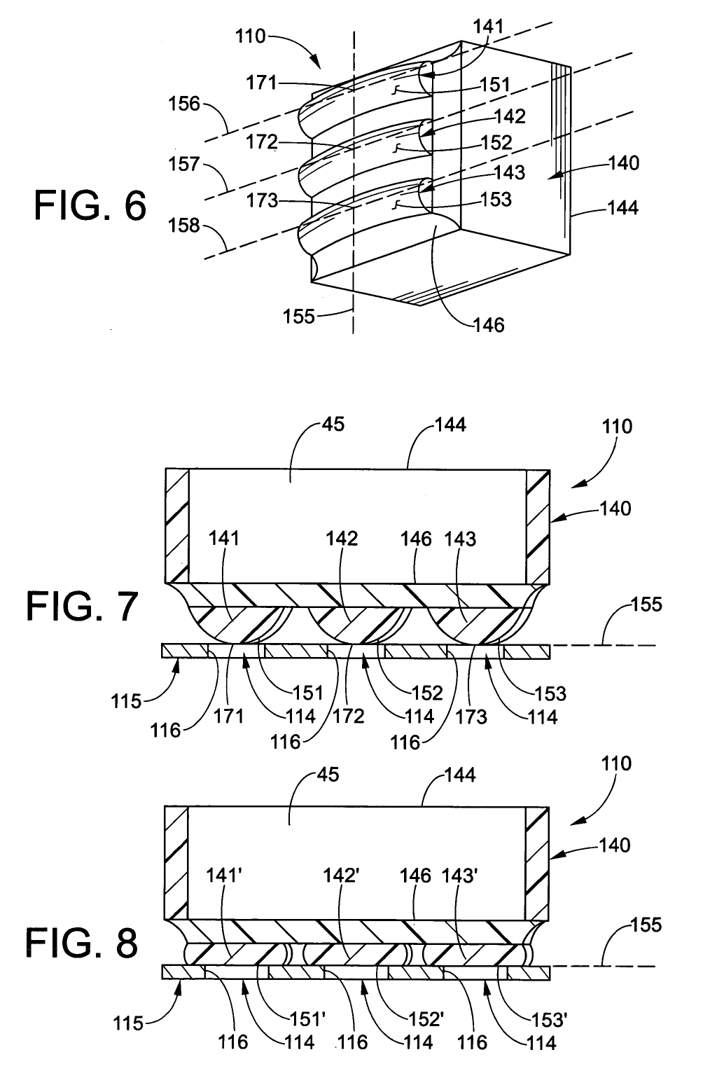

It is to be appreciated according to the first embodiment, and as shown in FIGS. 4 and 5, that the transport pad 10 includes a dome shaped contact portion 46 such that an apex 50 of the contact face 48 is generally centered with respect to nozzle plate 15 and thus is centered over the nozzle portion 14 when the transport clip TC and pad 10 are attached to the ink cartridge 12. The contact surface 48 is curvilinear or dome-shaped relative to a first axis 53 and a second axis 55 in the pre-compressed orientation shown in FIG. 4. First axis 53 is orthogonal to the second axis, and contact portion 46 includes a convex cross section in a plane through first axis 53 and perpendicular to body 40 and a convex cross section in a plane through second axis 55 and perpendicular to body 40. In the compressed orientation shown in FIG. 6, the contact portion 46 compresses to a generally rectilinear cross section 46′ including a more linear contact surface 48′ along axis 53.

The contact portion 46 of the pad 10, being a compressible elastic or elastomeric layer, creates a friction boundary condition over the nozzle plate 15 and orifices 16. It is to be appreciated that, in contrast to the present invention, a planar contact surface results in a compression force field which is dominant at the periphery of the contact zone. In the embodiments shown, the contact portion 46 and curved contact surface 48 results in compression or sealing forces applied progressively across the nozzle portion 14. Specifically, the compression forces progressively move from the apex 50 of the contact surface 48 toward the peripheral edge 17 of the nozzle plate 15 over the entire nozzle portion 14 during mounting. The domed configuration concentrates the compressive forces between the pad 10 and the orifices 16 to seal the orifices 16 and prevent leakage of ink therefrom. In this manner, a variable surface tension is created around the nozzle plate 15 and the nozzle portion 14. In particular, the surface tension is generally lower at the periphery 17 of the nozzle plate 15 relative to the center of nozzle portion 14. It is to be appreciated that the lower surface tension allows the transport clip TC to be installed or removed from the ink cartridge 12 without dislocating or disturbing the nozzle plate 15 and/or the flexible circuit 21. As the transport clip TC is pivoted away from the ink cartridge 12, during dismounting, the dome shaped contact surface 48 provides an inwardly advancing disengagement and inwardly advancing decreasing stress, both of which gradually decline inwardly from the periphery 17 of the nozzle plate 15. It is to be appreciated that the benefits of the aforementioned compression and decompression characteristics of the pad is further realized with repeated mounting and dismounting of the clip TC and pad 10 with the ink jet cartridge 12 as the cartridge 12 is swapped in and out of an ink jet recording apparatus.

Referring now to FIGS. 6-8, a second embodiment of a sealing member or transport pad 110 is shown. The pad 110, as shown, includes a body 140 having multiple and separate elongate contact portions 141, 142, 143, respectively, including contact faces or surfaces 151, 152, 153 spaced from one another. The body 140 has a lower end 144 and an upper end 146 and, preferably, is hollow for mounting on post 45 of the transportation clip. The contact portions 141, 142, 143 extend upward from the upper end 146. An associated nozzle plate 115 includes rows 114 each including multiple orifices 116. Contact portions 141, 142, 143 are aligned with rows 114 for the associated contact surfaces 151, 152, 153 to span orifices 116. As described above, it is to be appreciated that each of the contact surfaces 151, 152, 153 of the transport pad 110 is curved or convex relative to the body 140 and to a first axis 155 and the respective one of second axes 156, 157, 158 in the pre-compressed condition. The first axis 155 is orthogonal to second axes 156, 157 and 158. Prior to compression, the apexes 171, 172, 173 of the contact surfaces are generally centered laterally and longitudinally of the corresponding row 114 for the surfaces to span the central orifice in each row in the nozzle plate when transport clip TC and pad 110 are initially positioned for attachment to the ink cartridge. As the cartridge is moved into the transport clip toward the attached position, the contact portions 141, 142, 143 are progressively compressed to a generally rectangular cross-section 141′, 142′, 143′ as shown in FIG. 8 and in which contact surfaces 151′, 152′, 153′ are distended into the orifices 116.

Contact portions 141, 142, 143 of the pad 110 are compressible elastic layers which create a friction boundary condition over the nozzle plate 115 and the rows of orifices 116. Similar to the above described contact portion 46, the curved contact portions 141, 142, 143 and contact surfaces 151, 152, 153 result in compression or sealing forces being applied progressively along and laterally of the corresponding portion of nozzle plate 115 and orifices 116. Specifically, the compression force progressively moves from the apexes 171, 172, 173 of the contact surfaces 151, 152, 153 both longitudinally and laterally relative to the corresponding row of orifices in the nozzle plate during mounting. This configuration concentrates the compressive forces between the pad 110 and the orifices to seal the orifices and prevent leakage of ink therefrom. A variable surface tension is created around the nozzle plate and each of the nozzle portions. In particular, the surface tension is generally lower at the periphery of each of the nozzle plate orifices relative to the center of each nozzle portion. It is to be appreciated that the lower surface tension allows the transport clip TC to be installed or removed from the ink cartridge 12 without dislocating or disturbing the nozzle plate and/or flexible circuit 21. As the transport clip TC is pivoted away from the ink cartridge 12, during dismounting, the dome shaped contact surfaces 151, 152, 153 provide a longitudinally and laterally inward advancing disengagement and decreasing stress, both of which gradually decline around the peripheries of the plate openings. It is to be appreciated that the benefits of the aforementioned compression and decompression characteristics of the pad are further realized with repeated mounting and dismounting of the clip and pad 110 with the ink jet cartridge.

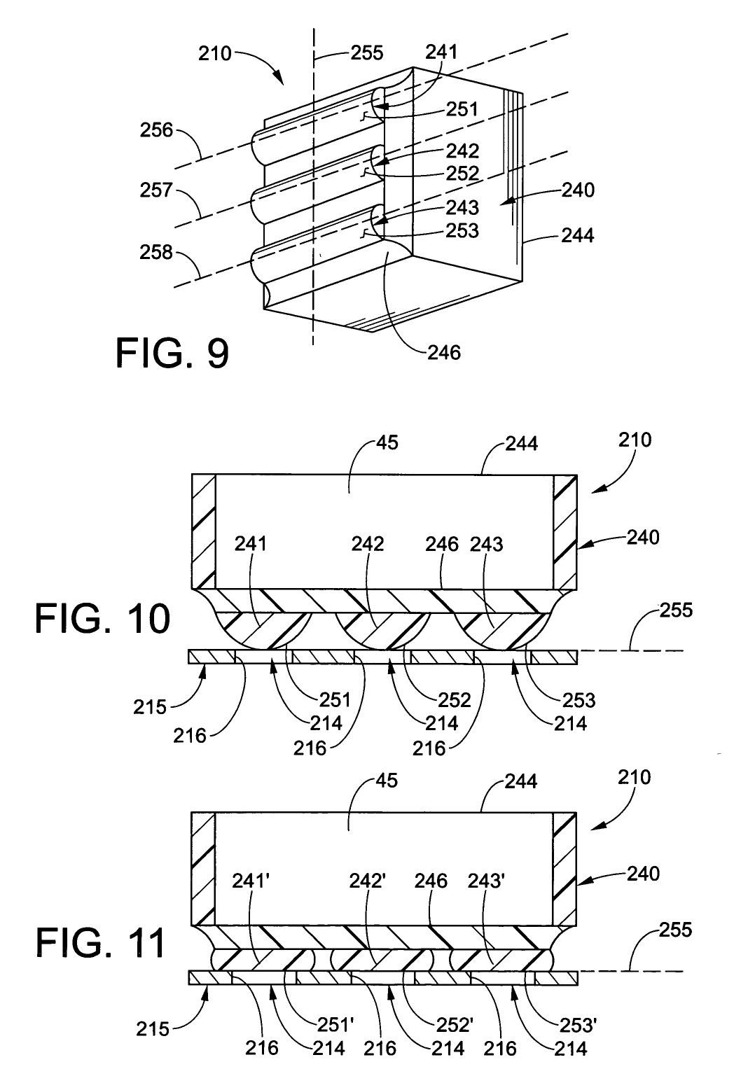

Referring now to FIGS. 9-11, a third embodiment of a sealing member or transport pad 210 is shown. The pad 210, as shown, includes a body 240 having multiple, separate elongate contact portions 241, 242, 243, respectively, including contact faces or surfaces 251, 252, 253. The body 240 has a lower end 244 and an upper end 246. Preferably, body 240 is hollow to facilitate mounting the pad on post 45 of the transport clip. The contact portions 241, 242, 243 extend upward from the upper end 246. As with the embodiment of FIGS. 7-9, an associated nozzle plate includes corresponding rows of orifices with which the contact surfaces 251, 252, 253 are aligned, as will become more apparent hereinafter. In this embodiment, each of the contact surfaces 251, 252, 253 of the transport pad 210 is linear with respect to the corresponding longitudinal axis 256, 257, 258 and is arcuate transverse to the corresponding axis and convex relative to body 240. In the uncompressed condition shown in FIG. 10, contact portions 241, 242, and 243 each overlie a corresponding row 214 of nozzle orifices 216 in a nozzle plate 215, and in the compressed condition shown in FIG. 11, each of the contact portions is compressed to a generally rectangular cross-section 241′, 242′, 243′ in which contact surfaces 251′, 252′, 253′ are distended into orifices 216 along axis 255.

Similar to the dome shaped pad 110, contact portions 241, 242, 243 of the pad 210 proximal to the contact surfaces 251, 252, 253 are compressible elastic layers which create a friction boundary condition over the nozzle plate 215 and orifices 216. The curved contact portions 241, 242, 243 and contact surfaces 251, 252, 253 result in compression or sealing forces being progressively applied laterally of the nozzle plate 215 and the rows of nozzle orifices. This configuration concentrates the compressive forces between the pad 210 and the orifices. A variable surface tension is created around the nozzle plate and each of the nozzle portions. In particular, the surface tension is generally lower along the edges of each of the nozzle plate orifices parallel to the axes 256, 257, 258 of each ink ejecting portion. It is to be appreciated that the lower surface tension allows the transport clip TC to be installed or removed from the ink cartridge without dislocating or disturbing the nozzle plate and/or flexible circuit 21. As the transport clip TC is pivoted away from the ink cartridge during dismounting, the curvilinear shaped contact surfaces 251, 252, 253 provide a laterally inward advancing disengagement and decreasing stress, both of which gradually decline. It will be appreciated that the benefits of the aforementioned compression and decompression characteristics are further realized with repeated mounting and dismounting of the clip TC and pad 210 with the ink jet cartridge.

While considerable emphasis has been placed herein on the structures and configuration of the disclosed embodiments of the invention, it will be appreciated that other embodiments, as well as modifications of the embodiments disclosed herein, can be made without departing from the principles of the invention. In this respect, it will be appreciated that the transport pad can be configured to accommodate various designs and structures of ink cartridges. This, as well as modifications of the embodiments shown, will be obvious and suggested to those skilled in the art from the disclosure herein. It is to be distinctly understood therefore that the foregoing descriptive matter is to be interpreted merely as illustrative of the present invention and not as a limitation thereof. It is intended that the invention be construed as including all such modifications and alterations as fall within the scope of the appended claims or the equivalents thereof.

Having thus described the invention, it is claimed:

1. A device for protecting and sealing an ink outlet of an ink jet cartridge comprising:
a sealing member including a contact portion having a profiled contact surface for sealing an ink outlet of a cartridge;
said contact surface being curvilinear; and,
a transport clip for selective attachment to an ink jet cartridge and supporting said sealing member for compressional engagement with the ink outlet of a cartridge when attached to the cartridge.

2. The device of claim 1, wherein said sealing member has a body and said contact portion has a convex cross section in a plane through a first axis and perpendicular to the body of said sealing member.

3. The device of claim 1, wherein said contact surface is convex in the direction of contact with the ink outlet.

4. The device of claim 2, wherein said sealing member, when compressed, provides a first surface tension laterally outwardly of an ink orifice and a second surface tension laterally inwardly of and greater than said first surface tension.

5. The device of claim 4, wherein said first surface tension progressively increases to said second surface tension.

6. A device for protecting and sealing ink orifices in a nozzle plate of an ink jet cartridge comprising:
a sealing member including a contact portion having a contact surface for sealing against an ink cartridge nozzle plate;
said contact surface being dome-shaped; and,
a transport clip for selective attachment to an ink jet cartridge and supporting said sealing member for compressional engagement with the nozzle plate of a cartridge.

7. The device of claim 6, wherein said contact surface is convex in the direction of contact with said nozzle plate.

8. The device of claim 6, wherein said sealing member has a body and said contact portion has a convex cross section in a plane through a first axis and perpendicular to said body of said sealing member.

9. The device of claim 8, wherein said contact portion has a convex cross section in a plane through a second axis and perpendicular to said body of said sealing member.

10. The device of claim 6, wherein said contact surface includes an apex, said contact surface curves away from said apex in at least a first and a second direction, and said first direction is orthogonal to said second direction.

11. The device of claim 10, wherein said sealing member, when compressed, provides a first surface tension laterally outwardly of an ink orifice in the nozzle plate of a cartridge and a second surface tension laterally inwardly of and greater than said first surface tension.

12. The device of claim 10, wherein said first surface tension progressively increases to said second surface tension.

13. A device for protecting and sealing ink orifices of an ink jet cartridge comprising:
a sealing member including a contact portion having a profiled contact surface for sealing ink orifices of a cartridge; and,
said contact surface being curvilinear.

14. A device for protecting and sealing ink orifices in a nozzle plate of an ink jet cartridge comprising:
a sealing member including a contact portion having a contact surface for sealing against an ink cartridge nozzle plate; and,
said contact surface being dome-shaped.

15. A device for protecting and sealing ink orifices of an ink jet cartridge comprising:
a sealing member including a plurality of contact portions each having a profiled contact surface for sealing ink orifices of a cartridge; and,
said contact surfaces being curvilinear.

16. The device of claim 15, wherein said contact portions are elongated and laterally spaced from one another.

17. A device for protecting and sealing ink orifices in a nozzle plate of an ink jet cartridge comprising:
a sealing member including a plurality of contact portions each having a contact surface for sealing against an ink cartridge nozzle plate; and,
said contact surfaces being dome-shaped.

18. The device of claim 17, wherein said contact portions are elongated and laterally spaced from one another.

19. A device for protecting and sealing ink orifices of an ink jet cartridge comprising:
a sealing member including a body having a contact portion thereon with a profiled contact surface for sealing ink orifices of a cartridge;
said contact surface being curvilinear; and,
said body being hollow for mounting on a post of a transport clip whereby said sealing member is supported for compressional engagement with the ink orifices of a cartridge when the transport clip is attached to the cartridge.

20. The device of claim 19, wherein said sealing member further includes a plurality of contact portions; and,
said contact portions are elongated and laterally spaced from one another.
